(19) United States
(12) Patent Application Publication
(10) Pub. No.: US 2021/0260937 A1
(43) Pub. Date: Aug. 26, 2021

(54) MEASURING DEVICE, DEVICE, SYSTEM, VEHICLE AND METHOD

(71) Applicant: Continental Reifen Deutschland GmbH, Hannover (DE)

(72) Inventors: Adrian Cyllik, Hannover (DE); Joerg Lehmann, Hannover (DE); Bernd Lange, Bueckeburg (DE)

(73) Assignee: Continental Reifen Deutschland GmbH, Hannover (DE)

(21) Appl. No.: 17/262,617

(22) PCT Filed: Jul. 22, 2019
(86) PCT No.: PCT/EP2019/069642

§ 371 Date: Jan. 22, 2021

(30) Foreign Application Priority Data
Aug. 22, 2018 (DE) 10 2018 214 154.1

(51) Int. Cl. B60C 23/04; G01M 17/02; G01P 15/00; H04Q 9/00

(52) U.S. Cl. CPC B60C 23/0489; G01M 17/02; H04Q 9/00; B60C 23/0493; G01P 15/00

(57) ABSTRACT

A measuring device for a deformable vehicle tire having a sensor unit, a first data processing unit, and a first radio unit, where the sensor unit is designed to be fastenable to the inside of the vehicle tire such that a radial acceleration acting in a radial direction on a tread of the vehicle tire can be detected by means of the sensor unit, where the first data processing unit is configured to determine a result value, relevant for a tire mileage of the vehicle tire, at least on the basis of the radial acceleration and at least one predetermined tire parameter of the vehicle tire, where each tire parameter characterizes a property of the vehicle tire, and where the first radio unit is designed to transmit a radio signal which represents the determined result value.

The invention relates to a measuring device, a device, a system, a vehicle and a method.

It is known from the prior art to fasten a measuring device to a vehicle wheel, in particular to the associated rim, wherein the actual tire mileage incurred is determined by means of the measuring device. However, such measuring devices have the disadvantage that they have to be subsequently fastened to the wheel. This fastening process results in additional costs, which, however, could be avoided.

The invention is based on the object of providing a technical solution which makes it possible for the tire mileage of a deformable vehicle tire to be ensured with the least possible additional outlay and/or with the lowest possible additional costs.

According to a first aspect of the invention, the object is achieved by means of a measuring device for a deformable vehicle tire, wherein the measuring device has a sensor unit, a first data processing unit and a first radio unit. The sensor unit is designed to be fastenable at the inside to the vehicle tire such that a radial acceleration acting in a radial direction on a tread of the vehicle tire can be detected by means of the sensor unit. The first data processing unit is configured to determine a result value, relevant for a tire mileage of the vehicle tire, at least on the basis of the radial acceleration and at least one predetermined tire parameter of the vehicle tire. Each tire parameter characterizes a property of the vehicle tire. The first radio unit is designed to transmit a radio signal which represents the determined result value.

The above-mentioned measuring device provides the advantage that the measuring device can be integrated into a measuring device which is often already present in a vehicle tire. Modern vehicle tires are in fact often equipped with measuring devices which measure the temperature of the vehicle tire and/or the internal pressure of the tire and process the corresponding measurement data, if appropriate by means of a data processing unit, and additionally transmit it, for example, to a receiver in the vehicle using a radio unit. The above-mentioned measuring device according to the invention can therefore be manufactured by adapting the known measuring device of the vehicle tire, but an additional sensor unit is provided which can be fastened to the inside of the vehicle tire in order to detect the radial acceleration. In one advantageous refinement, this sensor unit can also be combined and/or integrated with the sensors which are already present. Moreover, the first data processing unit can be formed by the already known data processing unit if said unit is subsequently configured to determine the result value in accordance with the specification of the first data processing unit.

The result value can be relevant and/or necessary for the actual calculation of the tire mileage of the vehicle tire. The result value can, for example, a tire angle speed of the vehicle tire, a translatory tire speed of the vehicle tire or a measuring distance of the vehicle tire. The result value can, however, also be a tire mileage of the vehicle tire.

A radio signal which represents the determined result value can be transmitted by means of the first radio unit. The radio signal can be transmitted, for example, to a stationary device which has a receiver for receiving the radio signal. However, it is also possible that the radio signal is transmitted by the first radio unit to a receiver of a vehicle on which the vehicle tire is used.

The measuring device explained above therefore provides the advantage that it can be provided with particularly low expenditure on a deformable vehicle tire, so that a tire mileage for the vehicle tire can be calculated directly or indirectly on the basis of the determined result value.

One advantageous refinement of the measuring device is distinguished in that at least one of the following parameters forms a tire parameter or one of the tire parameters: dynamic rolling radius of the vehicle tire, standardized rolling radius of the vehicle tire, radial distance of the sensor unit from a rotational axis of the vehicle tire, standardized radial distance of the sensor unit from the rotational axis of the vehicle tire, sampling rate of the sensor unit, period length of the sensor unit and predetermined correction factor for the vehicle tire. Each of the specified parameters can characterize a property of the vehicle tire. Therefore, one of the above-mentioned parameters or a plurality of the above-mentioned parameters can be respectively used as a tire parameter in order to determine the result value by means of the first data processing unit of the measuring device and on the basis of the detected radial acceleration and the above-mentioned at least one parameter.

A further advantageous refinement of the measuring device is distinguished in that the sensor unit is designed to detect the radial acceleration with a sampling rate of at maximum ⅛ Hz, 1/32 Hz, 1/64 Hz or 1/128 Hz. The sampling rate is at maximum 1/16 Hz. If the sampling rate is 1/16 Hz, the radial acceleration is measured by means of the sensor unit every 16 seconds. The period length is inversely proportional to the sampling rate. The period length is preferably greater than 8 seconds, 16 seconds, 32 seconds, 64 seconds or 128 seconds. It can therefore be effectively ensured that the detection of the radial acceleration requires particularly little electrical power. The measuring device is therefore particularly economical.

A further advantageous refinement of the measuring device is distinguished in that the result value is a tire angle speed of the vehicle tire, wherein the tire parameter or one of the tire parameters is formed by the standardized radial distance of the sensor unit from the rotational axis of the vehicle tire. The determination of the tire angle speed w can be carried out here on the basis of the following mathematical formula:

$$ω = \sqrt{\frac{{a}_{r , i}}{{r}_{s e n}^{n o r m}}}$$

The parameter a_{r,i} here represents the radial acceleration. The parameter rₛₑₙ^{norm} represents here the standardized distance of the sensor unit from the rotational axis of the vehicle tire.

A further advantageous refinement of the measuring device is distinguished in that the result value is a translatory tire speed of the vehicle, wherein the tire parameters are formed at least by the standardized radial distance of the sensor unit from the rotational axis of the vehicle tire and by the standardized rolling radius of the vehicle tire. In this context, the translatory tire speed v_{w} can follow, for example, on the basis of the following mathematical formula:

v_{w}=ω·r_{dyn}^{norm}

ω represents here the tire angle speed. This can be determined on the basis of the formula explained above. r_{dyn}^{norm} represents here the standardized rolling radius of the vehicle tire.

A further advantageous refinement of the measuring device is distinguished in that the result value is a measuring distance of the vehicle tire, wherein the tire parameters are formed at least by the standardized radial distance of the sensor unit from the rotational axis of the vehicle tire and by the standardized rolling radius of the vehicle tire. The termination of the standardized measuring distance denote here on a distance between a first measuring point ₍ₜᵢ₋₁) and the second measuring point (tᵢ). The measuring distance Δsᵢ can be determined on the basis of the following mathematical formula:

$$Δ {s}_{i} = {v}_{w} \cdot Δ {t}_{i} = \frac{{r}_{d y n}^{n o r m}}{\sqrt{{r}_{s e n}^{n o r m}}} \cdot \sqrt{{a}_{r , i}} \cdot Δ {t}_{i}$$

The standardized measuring distance is represented here by Δsᵢ. The time between the two measuring points is denoted as Δtᵢ. Reference is made to the preceding explanations with respect to the additional parameters which are used.

The determination of a measuring distance which is independent of the tire can be carried out on the basis of the following mathematical formula by means of the data processing unit:

$$m i l e a g {e}_{F P}^{n o r m} = {\sum }_{i} {s}_{i} = \frac{{r}_{d y n}^{n o r m}}{\sqrt{{r}_{s e n}^{n o r m}}} \cdot {\sum }_{i} ( \sqrt{{a}_{r , i}} \cdot Δ {t}_{i} )$$

In this context, the measuring distance which is independent of the tire is represented by mileage_{FP}^{norm}. Reference is made to the preceding explanations with respect to the additional parameters which are used. Furthermore, the sampling rate or the period length can also be taken into account as a further tire parameter for the determination of the measuring distance, or the determination can be based thereon.

A further refinement of the measuring device is distinguished in that the result value is a tire mileage of the vehicle tire, wherein the tire parameters are formed at least by the standardized radial distance of the sensor unit from the rotational axis of the vehicle tire, by the standardized rolling radius of the vehicle tire and by a predetermined correction factor for the vehicle tire, within the correction factor is based on a predetermined deviation of the radial acceleration detected by the sensor unit. The tire mileage is preferably the distance travelled by the vehicle tire by rolling. The tire mileage can also be referred to as the mileage reading. When the tire rolls, a deformation occurs in the tire contact area of the vehicle tire. This influences the version of the radial acceleration. In particular if the sensor unit is on the inside of the tire with respect to the tire contact area of the vehicle tire, the sensor unit detects a radial acceleration which is approximately zero. However, this does not correspond to the average radial acceleration of the vehicle tire. The detection of the radial acceleration in the tire contact area therefore brings about a disadvantageous influence on the determination of the tire mileage. In order to correct this disadvantageous influence, the correction factor is taken into account in the determination of the tire mileage. This correction factor can be predetermined by means of statistical determination processes. The determination of the tire mileage can be carried out on the basis of the following mathematical formula by means of the data processing unit:

mileage_{corr}^{norm}=mileage_{FP}^{norm}·f_{FP}(Tₛ)

The tire mileage is represented here by mileage_{corr}^{norm}. The measuring distance which is independent of the tire is represented here by mileage_{FP}^{norm} and can be determined in accordance with the above-mentioned explanations. The correction factor f_{FP} serves to correct the tire contact error occurring during the detection of the radial acceleration.

An advantageous refinement of the measuring device is distinguished in that the determination of a standardized tire mileage as a result value, in particular on the basis of the following mathematical formula, which can be carried out by means of the data processing unit:

$$mileage = m i l e a g {e}_{c o r r}^{n o r m} \cdot \frac{{f}_{dyn}^{t i r e}}{\sqrt{{f}_{s e n}^{t i r e}}}$$

The factor f_{dyn}^{tire} is a factor based on the dynamic rolling radius. fₛₑₙ^{tire} is a factor based on the radius of the sensor.

A further advantageous refinement of the measuring device is distinguished in that the detected radial acceleration refers to an average acceleration acting in the radial direction on the tread, and the correction factor is based on the random deviation of the detected radial acceleration from an actual average acceleration acting in the radial direction on the tread, and wherein the deviation occurs if during the detection of the radial acceleration the sensor unit is on the inside with respect to a contact face section of the vehicle tire. The contact face section of the vehicle tire can also be referred to as the tire contact area, the contact area or the footprint. The contact face section of the vehicle tire is the section of the tread of the vehicle tire which is in contact with the underlying surface and/or the road and/or maintains contact with the underlying surface/road. The term random deviation can be understood to be in particular a statistical deviation. This can be determined in advance by means of statistical measurements. The correction factor can be predetermined on the basis of the random deviation. The correction factor can represent a random deviation, at least indirectly. The area in which the measurement of the radial acceleration can be falsified is often present not only on the contact face but can also be detected in sections which adjoin it in the circumferential direction.

A further advantageous refinement of the measuring device is distinguished in that the correction factor is predetermined as a function of the radius of the vehicle tire and/or a radial distance of the sensor unit from a rotational axis of the vehicle tire. Therefore, the above-mentioned radius or the above mentioned distance can also be taken into account in the predetermination of the correction factor. The correction factor can in particular also be predetermined as a function of a diameter and/or a circumference of the vehicle tire. However, these are variables which are dependent on the radius and should therefore also be understood as included here, at least implicitly.

A further advantageous refinement of the measuring device is distinguished in that the correction factor is predetermined as a function of a or the sampling rate of the sensor unit. Therefore, for example relatively high sampling rates can give rise to a relatively small correction factor, or vice versa.

According to a second aspect of the invention, the object mentioned at the beginning is achieved by means of a device for determining a tire mileage. The device has a second radio unit and a second data processing unit. The second radio unit is designed to receive a radio signal of the first radio unit of a measuring device which has a sensor unit which can be fastened to the inside of the deformable vehicle tire and is designed to detect a radial acceleration acting in the radial direction on a tread of the vehicle tire. The radio signal represents a signal value determined by means of the radial acceleration or a signal value determined by means of a result value determined by the measuring device on the basis of at least the radial acceleration. The second data processing unit is configured to determine a tire mileage of the vehicle tire at least on the basis of the signal value and a correction factor. The correction factor is based on a predetermined deviation of the radial acceleration detected by the sensor unit.

The term “second” serves for differentiating purposes. The device therefore does not require two radio units or two data processing units. The second radio unit is designed to receive the radio signal. This radio signal represents a signal value. The signal value can be determined here by means of the radial acceleration which has been detected by means of a measuring device on the inside of a deformable vehicle tire. However, it is also possible for the signal value to represent a result value which has already been determined on the basis of the radial acceleration. This result value can be determined here on the basis of the radial acceleration and a further parameter. The result value can therefore be the result of data pre-processing. This can be carried out, for example, in the measuring device. The measuring device can therefore be embodied in accordance with the measuring device according to the first aspect of the invention. Reference is made at least in an analogous fashion to the preceding explanations, preferred features, effects and/or advantages such as have been explained in conjunction with the measuring device according to the first aspect and/or the associated advantageous refinements. However, the measuring device in accordance with the first aspect provides the determination of the result value. However, this is not absolutely necessary for the device according to the second aspect. This is because the radio signal can represent, as mentioned above, a signal value which is then determined by means of the radial acceleration. It is therefore particularly preferred that the signal value is either the detected radial acceleration or the determined result value.

The term predetermined deviation is preferably meant to refer to a deviation of the detected radial acceleration from the actual average acceleration acting in the radial direction on the tread of the vehicle tire. This deviation occurs if the radial acceleration is detected by the sensor unit when the sensor unit is located opposite a ground contact face of the vehicle tire. The radial acceleration is approximately zero here. However, this does not correspond to the actual, currently present, average value of the radial acceleration. In order to correct the detected radial acceleration for this reason, the correction factor is provided, said factor being based on a predetermined deviation which represents, for example, a statistical deviation. The tire mileage is preferably the distance travelled by the vehicle tire by rolling. The tire mileage can also be referred to as the mileage reading. The radial direction is preferably the radial direction of the vehicle tire. The device provides the advantage that a particularly precise and/or reliable tire mileage can be determined. This is because the correction factor is taken into account in the determination of the tire mileage. Said factor serves to correct the effects of the detected radial acceleration which does not correspond to the average value of the radial acceleration acting on the vehicle tire at every measurement.

The correction factor can be predetermined as a function of the radius of the vehicle tire and/or as a function of a radial distance of the sensor unit from a rotational axis of the vehicle tire. The correction factor can also be predetermined as a function of a diameter and/or a circumference of the vehicle tire. The two above-mentioned variables are, however, dependent on the radius of the vehicle tire, so that the corresponding dependences apply in an analogous fashion.

One advantageous refinement of the invention is distinguished by the fact that the second data processing unit is configured to determine the correction factor on the basis of the sampling rate of the sensor unit, the period length the sensor unit and/or a radius of the vehicle tire. Relatively high sampling rates can lead to a relatively low correction factor. The correction factor can be adapted to the respective vehicle tire by the second data processing unit. This applies in particular with respect to the geometric variables of the vehicle tire and/or the arrangement of the sensor unit of the measuring device by which the radio signal is received.

According to a third aspect of the invention, the object mentioned at the beginning is achieved by means of a system for determining a tire mileage. The system has a measuring device and a device. The measuring device is preferably a measuring device according to the first aspect of the invention and/or one of the associated advantageous refinements. However, it is also possible for the measuring device to be embodied according to a refinement such as has been explained in conjunction with the second aspect of the invention. The device is preferably embodied by means of a device according to the second aspect of the invention and/or one of the associated advantageous refinements. With respect to the measuring device and the device, reference is made in an analogous fashion to the preceding explanations, preferred features, effects and/or advantages such as have already been explained for the measuring device and/or the device.

For the system it is also provided that the first radio unit of the measuring device is designed to transmit the radio signal to the second radio unit of the device, and the second radio unit is designed to receive this radio signal. Therefore, the radial acceleration of the vehicle tire can be detected by the measuring device, and also a radio signal can be transmitted by means of the first radio unit of the measuring device to the second radio unit of the device. In this context, the radio signal can represent the radial acceleration as such, or a result value which is determined by the measuring device and has been determined at least on the basis of the radial acceleration and a further, predetermined tire parameter of the vehicle tire. After the reception of the radio signal by the second radio unit, the device can determine the tire mileage. In this context, the determination is carried out while taking into account a correction factor which is based on a predetermined deviation of the radial acceleration detected by the sensor unit. Therefore, particularly accurate and/or precise determination of the tire mileage can be ensured by means of the correction factor. The device of the system can be arranged in a stationary fashion. However, it is also possible for the device to be embodied as a handheld device. The device can be formed, example, by a mobile computer such as a tablet computer. However, it is also possible for the device to be coupled to the vehicle body of a motor vehicle. In this way, the device can, for example, be fastened directly or indirectly to the chassis of a motor vehicle.

According to a fourth aspect of the invention, the object mentioned at the beginning is achieved by means of a vehicle which has a plurality of deformable vehicle tires and a system. The system is preferably embodied according to the third aspect of the invention. It is also possible here for the system to be embodied according to one of the associated advantageous refinements. The sensor unit of the measuring device of the system is arranged on the inside of one of the vehicle tires in such a way that a radial acceleration acting in the radial direction on a tread of this vehicle tire can be detected by means of the sensor unit. The vehicle has, with reference made in an analogous fashion to the preceding explanations, preferred features, effects and/or advantages such as have been explained in conjunction with the measuring device according to the first aspect of the invention, the device according to the second aspect of the invention, the system according to the third aspect of the invention and/or one of the respectively associated advantageous refinements.

According to a fifth aspect of the invention, the object mentioned at the beginning is achieved by means of a method for determining a tire mileage. The method has the following steps of:

a) detecting a radial acceleration acting in the radial direction on a tread of the vehicle tire, by means of a sensor unit which is arranged on the inside of a deformable vehicle tire; and
b) determining a tire mileage of the vehicle tire at least on the basis of the radial acceleration and a correction factor by means of a data processing unit, wherein the correction factor is based on a predetermined deviation of the radial acceleration which is detected by the sensor unit.

For the method step b), the radial acceleration is therefore used to determine the tire mileage. Since the latter is subject to a statistically occurring deviation from an average radial acceleration which acts on the tread of the vehicle tire, the correction factor is also used to determine the tire mileage. This correction factor represents the predetermined deviation of the radial acceleration detected by the sensor unit. The predetermined deviation can be predetermined since it it is possible to use statistical methods to predict the magnitude of the deviation of the radial acceleration detected by means of the sensor unit from the average radial acceleration which actually acts on the tread of the vehicle tire. Therefore, the method with the steps a) and b) can be used to determine a particularly accurate tire mileage. The explanations, advantageous features, effects and/or advantages such as have been explained in relation to the preceding aspects of the invention can apply in an analogous fashion to the method.

Further features, advantages and possible applications of the present invention emerge from the following description of the exemplary embodiments and the figures. Here, all of the features described and/or illustrated in the figures form the subject matter of the invention individually and in any desired combination, even independently of the composition thereof in the individual claims, or the back-references thereof. In the figures, it is furthermore the case that the same reference designations are used for identical or similar objects.

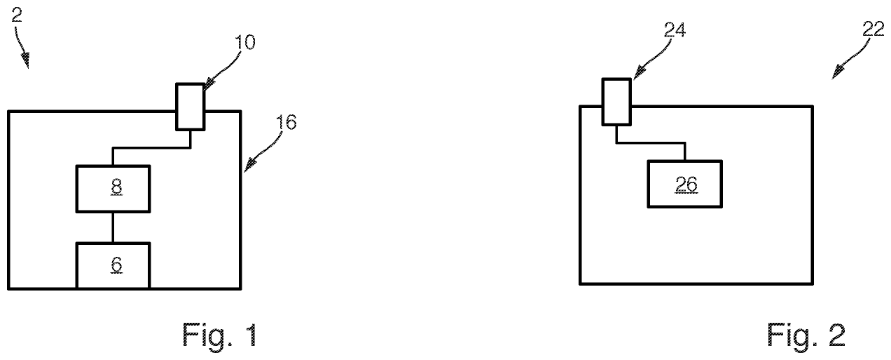

FIG. 1 shows an advantageous refinement of the measuring device in a schematic illustration,

FIG. 2 shows an advantageous refinement of the device in a schematic illustration,

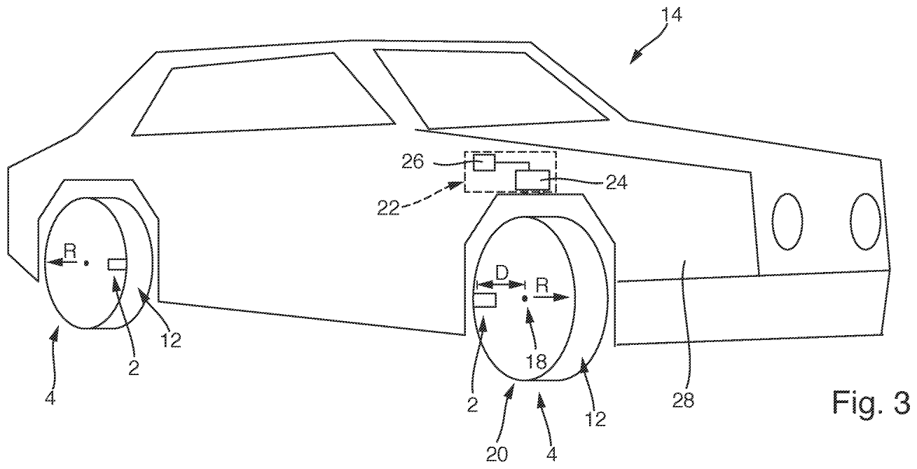

FIG. 3 shows an advantageous refinement of a vehicle in a schematic illustration,

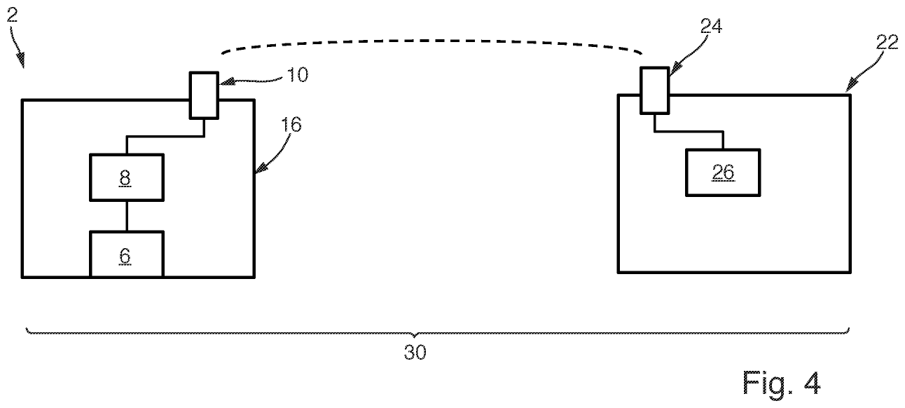

FIG. 4 shows an advantageous refinement of a system in a schematic illustration, and

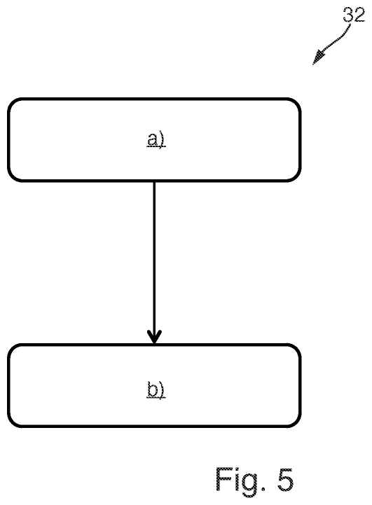

FIG. 5 shows an advantageous refinement of the method in a schematic illustration.

FIG. 1 is a schematic illustration of an advantageous refinement of a measuring device 2. The measuring device 2 serves as a measuring device 2 for a deformable vehicle tire 4. In this context, reference is made to figure in which an advantageous refinement of a vehicle 14 is illustrated schematically. The vehicle 14 has a plurality of deformable vehicle tires 4.

The measuring device 2 has a sensor unit 6, the first data processing unit 8 and the first radio unit 10. The sensor unit 6 is designed to be fastenable at the inside to the vehicle tire 4 such that a radial acceleration acting in a radial direction R on a tread 12 of the vehicle tire 4 can be detected by means of the sensor unit 6. In FIG. 3, such a measuring device 2 is provided for each vehicle tire 4 and illustrated schematically. The measuring device 2 is preferably arranged and/or fastened on the inside of the vehicle tire 4 so that the sensor unit 6 of the measuring device 2 is fastened on the inside of the vehicle tire 4 in such a way as to detect the radial acceleration acting in the radial direction R on the associated tread 12 of the respective vehicle tire 4.

As is apparent by way of example from FIG. 1, the measuring device 2 can have a housing 16, wherein the first data processing unit 8 is arranged inside the housing 16. Furthermore there is preferably provision that the sensor unit 6 is completely or at least partially arranged in the housing 16. The first radio unit 10 is arranged present or at least partially inside the housing 16. The measuring device 2 can therefore be embodied as a handheld measuring device 2. The measuring device 2 can be fastened to the inside of the vehicle tire 4 by means of the housing 16.

The first data processing unit 8 is configured to determine a result value, relevant for a tire mileage of the vehicle tire 4, at least on the basis of the radial acceleration and at least one predetermined tire parameter of the vehicle tire 4. The tire mileage is preferably the distance travelled by the vehicle tire 4 by rolling on an underlying surface.

The result value is determined by means of the first data processing unit 8 on the basis of the radial acceleration and at least one predetermined tire parameter. One of the following parameters of the vehicle tire can be used as a predetermined tire parameter: dynamic rolling radius of the vehicle tire 4, standardized rolling radius of the vehicle tire 4, radial distance D of the sensor unit 6 from a rotational axis 18 of the vehicle tire 4, standardized radial distance of the sensor unit 6 from the rotational axis 18 of the vehicle tire 4, sampling rate of the sensor unit 6, period length of the sensor unit 6 and predetermined correction factor for the vehicle tire 4. Each of the above-mentioned parameters can characterize a property of the vehicle tire 4. Each of the above-mentioned parameters can therefore form a tire parameter of the vehicle tire 4. Such tire parameters can also be predetermined. This can be done by means of measurements and/or by means of statistical measuring methods. The dynamic rolling radius of the vehicle tire 4 preferably corresponds to the effective rolling radius of the vehicle tire 4. The standardized rolling radius of the vehicle tire 4 can correspond here to the dynamic rolling radius of the vehicle tire 4 which is standardized to the radial distance of the sensor unit 6 from the rotational axis 18. Instead of the above-mentioned radial distance of the sensor unit 6, it is also possible to use another value of the vehicle tire 4 for standardization. For example the average radius of the vehicle tire 4 or for example, the diameter of the vehicle tire 4 are possible for this. The period length of the sensor unit 6 is preferably inversely proportional to the sampling rate of the sensor unit 6. When the measuring device 2 is being used, the associated sensor unit 6 may not detect the actual average acceleration in the radial direction R it is acting on the tread 12 of the vehicle tire 4. In particular, during the detection of the radial acceleration the sensor unit 6 may be on the inside of the vehicle tire 4, opposite the contact face section 20. The radial acceleration detected in this state is approximately zero. However, during a rotation of the vehicle tire 4 the rest of the tread 12 experiences a radial acceleration which deviates from this. The detected radial acceleration therefore deviates from the average radial acceleration acting on the tread 12. However, such detection of a “falsified” radial acceleration influences the calculation of a tire mileage for the vehicle tires 4.

It has therefore proven advantageous if the first data processing unit 8 is configured to determine the result value at least on the basis of the actually detected radial acceleration and at least one predetermined tire parameter of the vehicle tire 4. For example the dynamic or standardized rolling radius of the vehicle tire 4 and/or the radial distance D of the sensor unit 6 from the rotational axis 18 of the vehicle tire 4 can be taken into account here. The result value which is determined in this way can then characterize a property of the vehicle tire 4 and be transmitted by the first radio unit 10 by means of a radio signal which represents this determined result value.

Depending on the tire parameters which are taken into account during the determination of the result value alongside the radial acceleration, it is possible that the result value is, for example, the tire angle speed of the vehicle tire 4, the translatory tire speed of the vehicle tire 4 or a measuring distance of the vehicle tire 4. If the radio signal which represents the corresponding result value is transmitted by means of the first radio unit 10, this radio signal can be received by a device 22 such as is illustrated by way of example and schematically in FIG. 2. The device 22 has a second radio unit 24 and a second data processing unit 26. The second radio unit 24 is designed to receive the or a radio signal. The radio signal here can be the radio signal of the measuring device 2 such as has been explained above in conjunction with FIGS. 1 and 3. In this case, the radio signal represents a result value determined by the first data processing unit 8 of the measuring device 2. The latter is also referred to as a signal value if the radio signal is received by the second radio unit 24 of the device 22. This is because it is also possible that a radio signal received by the second radio unit 24 which does not originate from a measuring device 2, as is illustrated by way of example in FIG. 1, but rather by another measuring device 2 which determines the result value exclusively on the basis of the radial acceleration, and the radio signal therefore represents, for example, exclusively the radial acceleration. It is therefore possible that the radio signal which is received by the second radio unit 24 of the device 22 represents a signal value which is determined by the radial acceleration acting on a vehicle tire.

The second data processing unit 26 of the device 22 is configured to determine a tire mileage of the vehicle tire 4 at least on the basis of the signal value which is represented by the radio signal, and a correction factor, wherein the correction factor is based on a predetermined deviation of the radial acceleration detected by the sensor unit 6. The sensor unit 6 can be here the sensor unit 6 of the measuring device 2 such as has been explained, for example, in conjunction with FIG. 1. However, it is possible that the sensor unit 6 is one for detecting a radial acceleration of another measuring device 2, wherein this measuring device 2 has a radio unit which is designed to transmit a radio signal which represents the detected radial acceleration.

By taking into account the correction factor in the determination of the tire mileage it is possible to ensure that the influence of a deviation of the detected radial acceleration of the vehicle tire 4 from the actual average acceleration acting in the radial direction R on the tread 12 of the vehicle tire 4 can be compensated. The correction factor can be based here on a random deviation of the detected regional acceleration from an actual average acceleration acting in the radial direction R on the tread 12. The correction factor can therefore be determined by means of statistical evaluation of the detected deviation of the detected radial acceleration during preceding test investigations.

In practice it has been found that the deviations can also depend on the sampling rate or on the period length of the sensor unit 6. A particularly high sampling rate can ensure that the radial acceleration which actually acts on the tread 12 of the vehicle tire 4 can be detected precisely. However, this requires a large amount of power, which is something to avoid. There is therefore preferably provision that the sensor unit 6 is designed to detect the radial acceleration with a sampling rate of at maximum ⅛ Hz, 1/16 Hz, 1/32 Hz, 1/64 Hz or 1/128 Hz. This ensures that the radial acceleration is not sampled too frequently, and the power consumption of the measuring device 2 is therefore advantageously limited by the sampling of the radial acceleration. This can, however, result in an error during the detection of the average radial acceleration or a deviation during the actually detected radial acceleration by means of the sensor unit 6 in comparison with the average radial acceleration which is actually present at the vehicle tire 4. However, in practice it has been determined through statistical investigations that this error in the above-mentioned sampling rate can be at least essentially compensated again by a correction factor. This is therefore also taken into account during the detection of the tire mileage. It has therefore also proven advantageous if the correction factor is predetermined as a function of the radius of the vehicle tire 4 and/or as a function of a radial distance D of the sensor unit 6 of the measuring device 2 from a rotational axis 18 of the vehicle tire 4. Furthermore, it has proven advantageous if the correction factor is predetermined as a function of a or the sampling rate of the sensor unit 6.

In practice it has proven advantageous if the device 22 is embodied as a stationary device 22 or as a mobile device 22. The device 22 can therefore be embodied, for example, as a device which is installing a stationary fashion. However it is also possible for the device 22 to be embodied by a mobile handheld computer such as, for example, a cell phone or a tablet computer. The second radio unit 24 can be embodied, for example, as a Bluetooth radio unit. Thus in this case the second radio unit 24 can communicate with the first radio unit 10 of the measuring device 2 in order to exchange the radio signal, it has also proven advantageous if the first radio unit 10 is also embodied as a Bluetooth radio unit. However, is basically also possible to use other transmission standards and/or proprietary radio methods for transmitting the radio signal.

A further advantageous arrangement of the device 22 is illustrated schematically in FIG. 3. In this context, the device 22 is assigned to the bodywork 28 of the motor vehicle 14. The second data processing unit 26 can be coupled here to a control unit (not illustrated) of the vehicle 14 in order to transmit the determined tire mileage to the control unit of the motor vehicle 14.

A further advantageous refinement of a combination of the measuring device 2 and the device 22 is illustrated schematically in FIG. 4. The measuring device 2 and the device 22 form a system 30 in this case. Furthermore, the transmission of the radio signal is indicated schematically by the dashed line between the first radio unit 10 and the second radio unit 24.

The method 32 is illustrated schematically in FIG. 5. The method 30 has a first method step a) and a second method step b). The method step b) follows the method step a). However, it is basically possible for further intermediate steps to be executed between the first method step a) and the second method step b). Moreover, method step b) can also be followed by further method steps.

In step a) a radial acceleration acting in the radial direction R on a tread 12 of the vehicle tire 4 is detected by means of a sensor unit 6 which is arranged on the inside of a deformable vehicle tire 4. In step b) a tire mileage of the vehicle tire 4 is determined at least on the basis of the radial acceleration and a correction factor by means of a data processing unit, wherein the correction factor is based on a predetermined deviation of the radial acceleration which is detected by the sensor unit 6. The data processing unit is preferably the second data processing unit 26 of a device 22. The sensor unit 6 is preferably the sensor unit 6 of a measuring device 2. For the method, reference is made at least in an analogous fashion to the preceding explanations, preferred features, effects and/or advantages such as have been explained in conjunction with the measuring device 2, the device 22, the vehicle 14 and/or the system 30.

In addition it is to be noted that “having” does not exclude any other elements or steps and “a” or “an” does not exclude a plurality. In addition it is to be noted that features which have been described with reference to one of the above exemplary embodiments can also be used in combination with other features of other exemplary embodiments described above. Reference designations in the claims are not to be considered to be limiting.

### LIST OF REFERENCE SIGNS

R Radial direction
D Distance
2 Measuring device
4 Vehicle tire
6 Sensor unit
8 First data processing unit
10 First radio unit
12 Tread
14 Vehicle
16 Housing
18 Rotational axis
20 Contact face section
22 Device
24 Second radio unit
26 Second data processing unit
28 Vehicle body
30 System
32 Method:

1.-15. (canceled)

16. A measuring device for a deformable vehicle tire comprising:
a sensor unit,
a first data processing unit, and
a first radio unit (10);
wherein the sensor unit is designed to be fastenable to the inside of the vehicle tire such that a radial acceleration acting in a radial direction (R) on a tread of the vehicle tire can be detected by means of the sensor unit;
wherein the first data processing unit is configured to determine a result value, relevant for a tire mileage of the vehicle tire, at least on the basis of the radial acceleration and at least one predetermined tire parameter of the vehicle tire;
wherein each tire parameter characterizes a property of the vehicle tire; and,
wherein the first radio unit is designed to transmit a radio signal which represents the determined result value.

17. The measuring device as claimed in claim 16, wherein the at least one predetermined tire parameter is selected from the group consisting of dynamic rolling radius of the vehicle tire, standardized rolling radius of the vehicle tire, radial distance (D) of the sensor unit from a rotational axis of the vehicle tire, standardized radial distance (D) of the sensor unit from the rotational axis of the vehicle tire, sampling rate of the sensor unit, period length of the sensor unit, predetermined correction factor for the vehicle tire, or any combination thereof.

18. The measuring device as claimed in claim 16, wherein the sensor unit is designed to detect the radial acceleration with a sampling rate of at maximum ⅛ Hz, 1/16 Hz, 1/32 Hz, 1/64 Hz or 1/128 Hz.

19. The measuring device as claimed in claim 16, wherein the result value is a tire angle speed of the vehicle tire, and wherein the at least one predetermined tire parameter is formed by the standardized radial distance of the sensor unit from the rotational axis of the vehicle tire.

20. The measuring device as claimed in claim 16, wherein the result value is a translatory tire speed of the vehicle tire, wherein the at least one predetermined tire parameter is formed at least by the standardized radial distance of the sensor unit from the rotational axis of the vehicle tire and by the standardized rolling radius of the vehicle tire.

21. The measuring device as claimed in claim 16, wherein the result value is a measuring distance of the vehicle tire, and wherein the at least one predetermined tire parameter is formed at least by the standardized radial distance of the sensor unit from the rotational axis of the vehicle tire and by the standardized rolling radius of the vehicle tire.

22. The measuring device as claimed in claim 16, wherein the result value is a tire mileage of the vehicle tire, and wherein the at least one predetermined tire parameter is formed at least by the standardized radial distance of the sensor unit from the rotational axis of the vehicle tire, the standardized rolling radius of the vehicle tire and a predefined correction factor based on a predefined deviation of the detected radial acceleration from the sensor unit.

23. The measuring device as claimed in claim 22, wherein the detected radial acceleration refers to an average acceleration acting in the radial direction (R) on the tread, and the correction factor is based on the random deviation of the detected radial acceleration from an actual average acceleration acting in the radial direction (R) on the tread (12), and wherein the deviation occurs if during the detection of the radial acceleration the sensor unit (6) is on the inside with respect to a contact face section (20) of the vehicle tire (4).

24. The measuring device as claimed in claim 22, wherein the correction factor is predetermined as a function of the radius of the vehicle tire and/or a radial distance (D) of the sensor unit from a rotational axis of the vehicle tire.

25. The measuring device as claimed in claim 22, wherein the correction factor is predetermined as a function of a or the sampling rate of the sensor unit.

26. The measuring device as claimed in claim 16 further comprising:
a second radio unit, and
a second data processing unit;
wherein the second radio unit is designed to receive a radio signal of the first radio unit of a measuring device which has a sensor unit which can be fastened to the inside of the deformable vehicle tire and is designed to detect a radial acceleration acting in the radial direction (R) on a tread of the vehicle tire;
wherein the radio signal represents a signal value determined by means of the radial acceleration or by means of a result value determined by the measuring device on the basis of at least the radial acceleration;
wherein the second data processing unit is configured to determine a tire mileage of the vehicle tire at least on the basis of the signal value and a correction factor; and,
wherein the correction factor is based on a predetermined deviation of the radial acceleration detected by the sensor unit.

27. The measuring device as claimed in claim 26, wherein the second data processing unit is configured to determine the correction factor on the basis of the sampling rate of the sensor unit of the period length of the sensor unit and/or a radius of the vehicle tire.

28. The measuring device as claimed in claim 26, which is part of a system for determining a tire mileage, wherein the first radio unit of the measuring device is designed to transmit the radio signal to the second radio unit of the device, and wherein the second radio unit is designed to receive this radio signal.

29. The measuring device as claimed in claim 28, which is part of a vehicle having a plurality of deformable vehicle tires and a system, wherein the sensor unit of the measuring device is arranged on the inside of one of the vehicle tires in such a way that a radial acceleration acting in the radial direction (R) on a tread can be detected by means of the sensor unit.

30. A method for determining a tire mileage comprising:
a) detecting a radial acceleration acting in the radial direction (R) on a tread of a deformable vehicle tire by means of a sensor unit which is arranged on the inside of the deformable vehicle tire; and,
b) determining a tire mileage of the deformable vehicle tire at least on the basis of the radial acceleration and a correction factor by means of a data processing unit, wherein the correction factor is based on a predetermined deviation of the radial acceleration which is detected by the sensor unit.
